(19) United States
(12) Patent Application Publication
(10) Pub. No.: US 2018/0276472 A1
(43) Pub. Date: Sep. 27, 2018

(54) INFORMATION DISPLAY METHOD, SYSTEM, PROGRAM, AND INFORMATION DISPLAY DEVICE

(71) Applicant: SEIKO EPSON CORPORATION, Tokyo (JP)

(72) Inventor: Seiichi TANAKA, Nagawa-machi (JP)

(73) Assignee: SEIKO EPSON CORPORATION, Tokyo (JP)

(21) Appl. No.: 15/920,293

(22) Filed: Mar. 13, 2018

(30) Foreign Application Priority Data
Mar. 23, 2017 (JP) 2017-058256

(51) Int. Cl. G06K 9/00; G06T 11/60

(52) U.S. Cl. CPC G06K 9/00671; G04G 21/04; G06T 11/60

(57) ABSTRACT

An information display method includes recognizing an electronic timepiece included as an imaged subject in an image, and an indicating element that indicates information in the electronic timepiece, receiving data relating to information indicated by the electronic timepiece from the electronic timepiece, associating information extracted from the data with the indicating element, based on specification information of the electronic timepiece, and displaying an annotation image relating to the information extracted from the data in association with the indicating element, along with the image.

### CROSS-REFERENCE TO RELATED APPLICATION

This nonprovisional application claims the benefit of Japanese Patent Application No. 2017-058256 filed Mar. 23, 2017, the enter disclosure which is incorporated herein by reference.

### BACKGROUND

### 1. Technical Field

The present invention relates to an information display method, a system, a program, and an information display device.

### 2. Related Art

An electronic timepiece is known in which a physical quantity such as temperature, altitude, barometric pressure is measured so as to be displayed using an information indicating hand different from an indicating hand for indicating the time. For example, JP-A-2013-57517 discloses an electronic timepiece including physical quantity measuring unit that measures a physical quantity such as temperature, a dedicated information indicating hand that indicates a physical quantity measurement value, a scale unit that has a dedicated scale displayed thereon in order for the indicating hand to indicate the measurement value, and a display unit that displays numerical values so as to specify upper and lower ranges of the physical quantity measurement value displayed by the scale unit indicating the scale.

However, according to the electronic timepiece as disclosed in JP-A-2013-57517, the information indicating hand and the dedicated scale unit which indicate the physical quantity measurement value are disposed separately from an indicating hand and a scale unit for displaying the time. Accordingly, the scale or the indicating hand on the dial of the electronic timepiece has a complicated layout. In some cases, one set of the information indicating hand and the scale unit has to be used selectively in order to indicate a plurality of types of information. As a result, in some cases, it is difficult for a user to correctly read a value indicated by the information indicating hand and the scale unit.

On the other hand, in recent years, a mobile terminal device such as a smartphone and a tablet computer has been widely used, and it becomes common that the user possesses the mobile terminal device along with the electronic timepiece. Many mobile terminal devices include a camera and a display, which can be used so as to provide various information items for the user.

### SUMMARY

An advantage of some aspects of the invention is to provide a new and improved information display method, system, program, and information display device, in which an information display device such as a mobile terminal device, is combined with an electronic timepiece so that a user can be prompted to correctly read information indicated by the electronic timepiece.

An information display method according to an aspect of the invention includes recognizing an electronic timepiece included as an imaged subject in an image, and an indicating element that indicates information in the electronic timepiece, receiving data relating to information indicated by the electronic timepiece from the electronic timepiece, associating information extracted from the data with the indicating element, based on specification information of the electronic timepiece, and displaying an annotation image relating to the information extracted from the data in association with the indicating element, along with the image.

According to this configuration, a user can refer to the annotation image relating to the information indicated in the electronic timepiece by holding up the information display device such as a mobile terminal device, over the electronic timepiece. The annotation image is displayed in association with the indicating element such as an indicating hand of the electronic timepiece. In this manner, it is possible to prompt the user to correctly read the information indicated in the electronic timepiece.

In the information display method, the indicating element may include a dial and an indicating hand that indicates the dial. In the displaying the annotation image, the annotation image may be displayed in association with the indicating hand.

According to this configuration, in a case where various types of information are indicated using a dial and the indicating hand which are the indicating elements unique to the electronic timepiece, it is possible to prompt the user to correctly read the information.

In the information display method, the information indicated by the electronic timepiece may include information based on a measurement value of a sensor included in the electronic timepiece, or information based on a measurement value of a sensor of an external device which is received from the external device.

According to this configuration, in a case where information based on a measurement value of a sensor whose reading method is different from that of the time or whose reading method varies depending on a type is indicated in the electronic timepiece, it is possible to prompt the user to correctly read the information.

In the information display method, the indicating element may include a first indicating element and a second indicating element. The information indicated by the electronic timepiece may include a first value indicated by the first indicating element, and a second value indicated by the second indicating element. In the displaying the annotation image, a first annotation image relating to the first value may be displayed in association with the first indicating element, and a second annotation image relating to the second value may be displayed in association with the second indicating element.

According to this configuration, in a case where a plurality of the values are respectively indicated by a plurality of the indicating elements of the electronic timepiece, it is possible to prompt the user to correctly read each of the values.

In the information display method, in the displaying the annotation image, a third annotation image relating to a third value in which the first value and the second value are integrated with each other may be displayed along with the first annotation image and the second annotation image.

According to this configuration, in a case where a plurality of the values respectively indicated by a plurality of indicating elements of the electronic timepiece are obtained by decomposing a single value, it is possible to prompt the user to correctly read the value in which a plurality of values are integrated with each other.

In the information display method, the electronic timepiece may indicate the value in accordance with any one of a plurality of settable indicating modes. The information indicated by the electronic timepiece may include the indicating mode set in the electronic timepiece. In the displaying the annotation image, the annotation image relating to the indicating mode may be displayed in association with the indicating element that indicates the indicating mode.

According to this configuration, it is possible to prompt the user to correctly read the indicating mode set in the electronic timepiece.

The information display method may further include transmitting a data request to the electronic timepiece in a case where the electronic timepiece is recognized in recognizing the electronic timepiece and the indicating element.

According to this configuration, power consumption can be saved by performing communication between the information display device such as the mobile terminal device, and the electronic timepiece.

A system according to an aspect of the invention includes an electronic timepiece, and an information display device. The electronic timepiece includes an indicating element that indicates information, a drive control unit that controls driving of the indicating element, and an antenna that transmits data relating to the information to the information display device. The information display device includes a camera that acquires an image, an image recognition unit that recognizes the electronic timepiece and the indicating element which are included as an imaged subject in the image, an antenna that receives the data from the electronic timepiece, an analysis unit that associates information extracted from the data with the indicating element, based on specification information of the electronic timepiece, and a display that displays an annotation image relating to the information extracted from the data in association with the indicating element, along with the image.

A program according to an aspect of the invention causes a processor of a computer to function as an image recognition unit that recognizes an electronic timepiece included as an imaged subject in an image, and an indicating element which indicates information in the electronic timepiece, a communication control unit that receives data relating to information indicated by the electronic timepiece from the timepiece, an analysis unit that associates information extracted from the data with the indicating element, based on specification information of the electronic timepiece, and a display control unit that displays an annotation image relating to the information extracted from the data in association with the indicating element, along with the image.

An information display device according to an aspect of the invention includes a camera that acquires an image, an image recognition unit that recognizes an electronic timepiece included as an imaged subject in the image, and an indicating element which indicates information in the electronic timepiece, an antenna that receives data relating to information indicated by the electronic timepiece from the electronic timepiece, an analysis unit that associates information extracted from the data with the indicating element, based on specification information of the electronic timepiece, and a display that displays an annotation image relating to the information extracted from the data in association with the indicating element, along with the image.

### BRIEF DESCRIPTION OF THE DRAWINGS

The invention will be described with reference to the accompanying drawings, wherein like numbers reference like elements.

FIG. 1 is a front view of an electronic timepiece according to an embodiment of the invention.

FIG. 2 is a schematic block diagram illustrating a circuit configuration of the electronic timepiece illustrated in FIG. 1.

FIG. 3 is a flowchart illustrating a process example in the electronic timepiece according to the embodiment of the invention.

FIG. 4 illustrates a configuration of a system including the electronic timepiece according to the embodiment of the invention.

FIG. 5 is a schematic block diagram illustrating a configuration of a smartphone according to the embodiment of the invention.

FIG. 6 is a flowchart illustrating an example of an information display method according to the embodiment of the invention.

FIG. 7 illustrates a first screen display example according to the embodiment of the invention.

FIG. 8 illustrates a second screen display example according to the embodiment of the invention.

FIG. 9 illustrates a third screen display example according to the embodiment of the invention.

FIG. 10 illustrates a fourth screen display example according to the embodiment of the invention.

FIG. 11 illustrates a fifth screen display example according to the embodiment of the invention.

FIG. 12 illustrates a sixth screen display example according to the embodiment of the invention.

### DESCRIPTION OF EXEMPLARY EMBODIMENTS

Hereinafter, a preferred embodiment according to the invention will be described in detail with reference to the accompanying drawings. In the description herein and the drawings, the same reference numerals will be given to configuration elements having substantially the same functional configuration, and repeated description will be omitted.

### Configuration of Electronic Timepiece

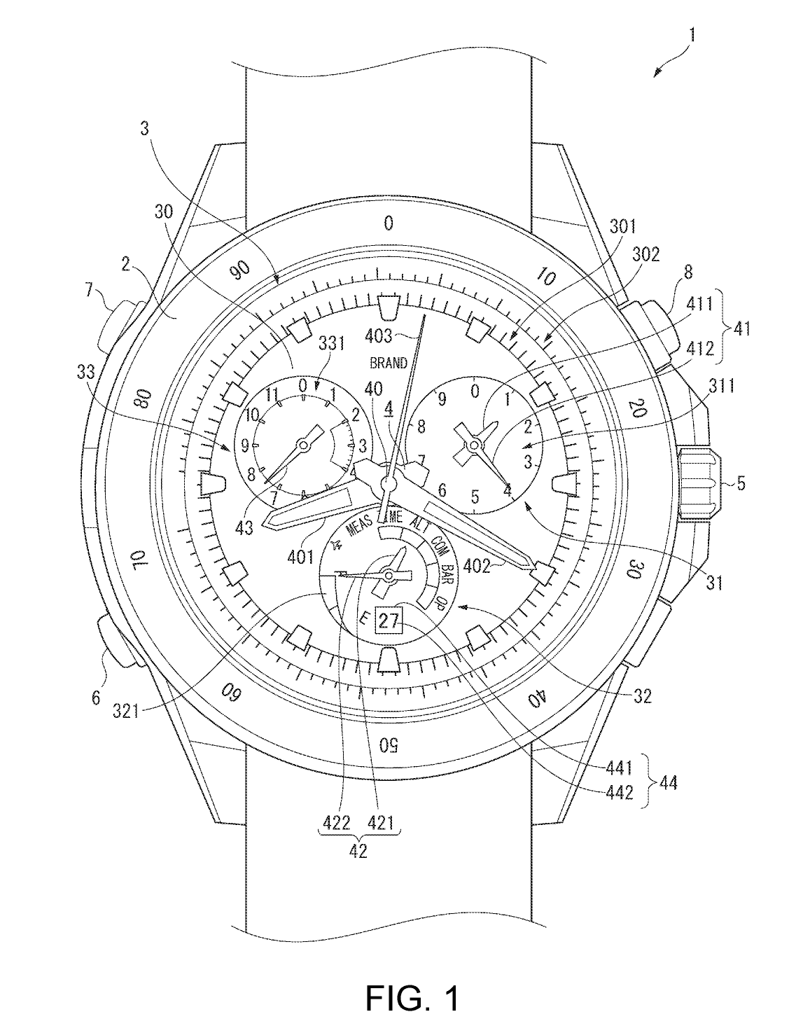

FIG. 1 is a front view of an electronic timepiece according to the embodiment of the invention. Referring to FIG. 1, an electronic timepiece 1 is a wrist watch worn on a wrist of a user. The electronic timepiece 1 includes an exterior case 2, a disk-shaped dial 3, an indicating hand 4 that indicates the dial 3, and a crown 5, an A-button 6, a B-button 7, and a C-button 8 which are operation members. The dial 3 includes a main dial 30, and a first sub dial 31, a second sub dial 32, and a third sub dial 33 which are arranged in a partial region of the main dial 30. The indicating hand 4 includes a center hand 40 (hour hand 401, minute hand 402, and chronograph second hand 403) that indicates the main dial 30, a first sub indicating hand 41 (short hand 411 and long hand 412) that indicates the first sub dial 31, a second sub indicating hand 42 (short hand 421 and long hand 422) that indicates the second sub dial 32, and a small second hand 43 that indicates the third sub dial 33. The electronic timepiece 1 includes a date display unit 44 disposed inside the second sub dial 32. The date display unit 44 includes a small window 441 and a display plate 442. Each hand included in the indicating hand 4 and the display plate 442 of the date display unit 44 are driven by a motor disposed inside a movement (not illustrated) of the electronic timepiece 1.

The main dial 30 includes a first scale 301 (60 divisions) disposed on an outer periphery and a second scale 302 (100 divisions). The first scale 301 is used when an hour hand 401 and a minute hand 402 indicate the time, and is additionally used when indicating a sensor measurement value. The second scale 302 is used when indicating the sensor measurement value. The first sub dial 31 is disposed in a direction of 2 o'clock when viewed from a plane center of the main dial 30. The first sub dial 31 includes a scale 311 (10 divisions) disposed on the outer periphery. The second sub dial 32 is disposed in a direction of 6 o'clock direction when viewed from the plane center of the main dial 30. The second sub dial 32 includes a portion where characters such as “MEAS”, “TIME”, “ALT”, “BAR”, and “OP” are marked on the outer periphery, and a portion having a scale 321 marked thereon for indicating battery remaining capacity. The third sub dial 33 is disposed in a direction of 10 o'clock when viewed from the plane center of the main dial 30. The third sub dial 33 includes a scale 331 (12 divisions) disposed on the outer periphery.

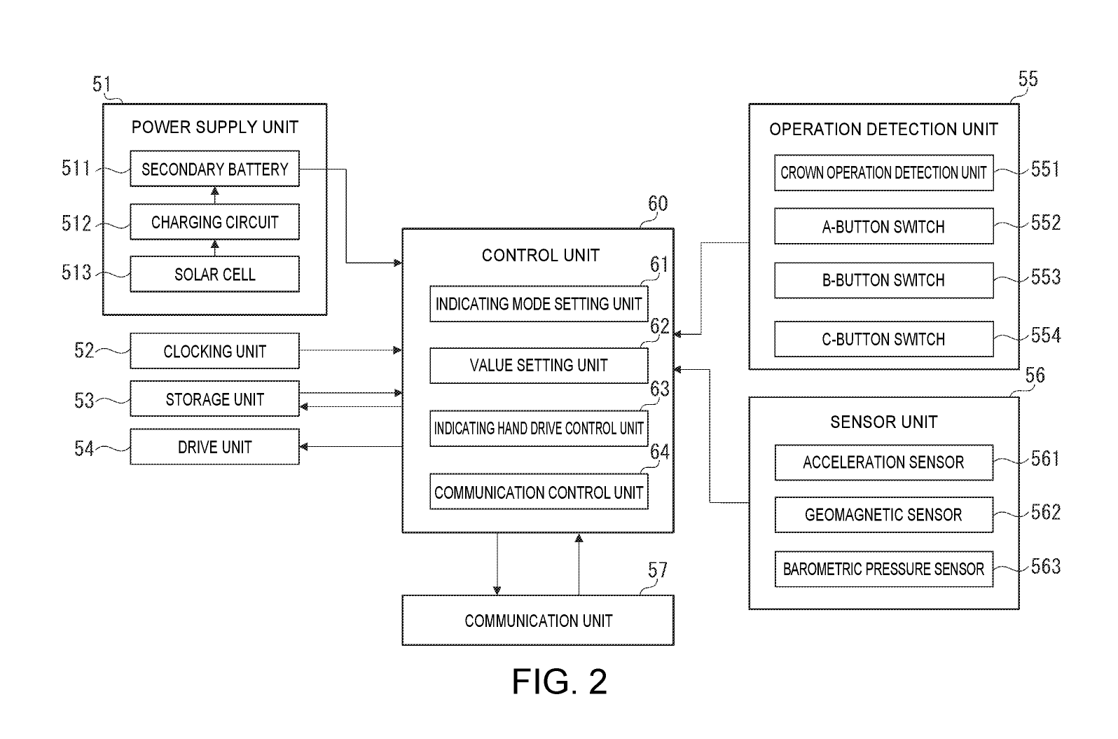

FIG. 2 is a schematic block diagram illustrating a circuit configuration of the electronic timepiece illustrated in FIG. 1. Referring to FIG. 2, the electronic timepiece 1 includes a power supply unit 51, a clocking unit 52, a storage unit 53, a drive unit 54, an operation detection unit 55, a sensor unit 56, a communication unit 57, and a control unit 60.

The power supply unit 51 includes a secondary battery 511 configured to include a lithium-ion battery, a charging circuit 512, and a solar cell 513. The secondary battery 511 is charged with electric power generated by the solar cell 513 via the charging circuit 512, and supplies the electric power to each unit of the electronic timepiece 1. A voltage detection circuit (not illustrated) connected to the secondary battery 511 outputs a signal indicating the remaining battery capacity to the control unit 60.

The clocking unit 52 updates time data using a reference signal generated through frequency-dividing of an oscillation signal of a crystal oscillator. The clocking unit 52 outputs the time data to the control unit 60. The clocking unit 52 and the storage unit 53 may be integrally installed in a microcontroller configuring the control unit 60.

The storage unit 53 is configured to include a random access memory (RAM) and a read only memory (ROM), and stores a program executed by the control unit 60 and data used for executing the program. The storage unit 53 may store a measurement value of various sensors included in the sensor unit 56 (to be described later) in association with the time.

The drive unit 54 includes a drive mechanism for driving the indicating element that indicates information in the electronic timepiece 1, that is, the center hand 40, the first sub indicating hand 41, the second sub indicating hand 42, and the small secondhand 43 which configure the indicating hand 4, and the display plate 442 of the date display unit 44, respectively. For example, the drive mechanism is configured to include a stepping motor and a train wheel, and rotationally drives each indicating hand by driving the stepping motor in response to a drive pulse input from the control unit 60.

The operation detection unit 55 includes a crown operation detection unit 551, an A-button switch 552, a B-button switch 553, and a C-button switch 554. The crown operation detection unit 551 detects the number of pullout stages and a rotation amount of the crown 5. The A-button switch 552, the B-button switch 553, and the C-button switch 554 detect that the A-button 6, the B-button 7, and the C-button 8 are pressed or released by a user. Each detection unit outputs a detection signal to the control unit 60.

The sensor unit 56 includes an acceleration sensor 561, a geomagnetic sensor 562, and a barometric pressure sensor 563. In addition to these sensors, the sensor unit 56 may also include sensors providing various measurement values, including those not described in a specific example (to be described later), such as a temperature sensor or a UV sensor. The sensor unit 56 outputs a measurement value of various sensors to the control unit 60. The sensor measurement value may be used on a real time basis in the control unit 60, or may be stored in the storage unit 53 in association with the time.

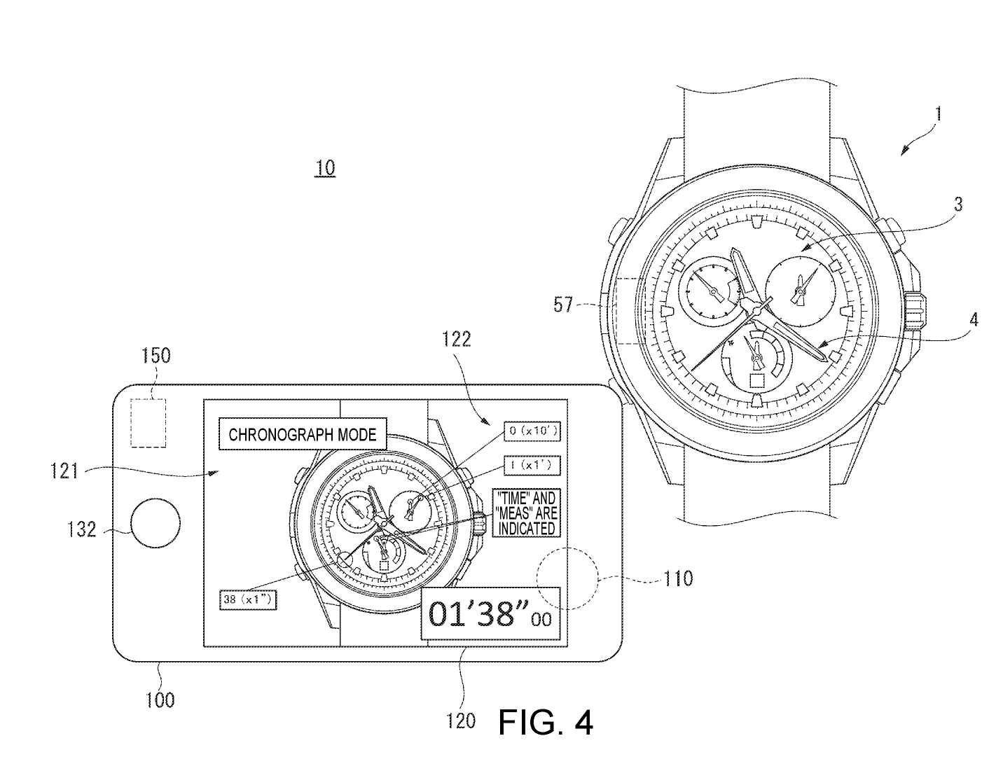

The communication unit 57 includes a device such as a communication circuit and an antenna for performing communication between the electronic timepiece 1 and an external device. For example, the communication unit 57 performs inter-device communication with the external device in accordance with a communication procedure such as the Bluetooth (registered trademark). More specifically, for example, the communication unit 57 performs the inter-device communication with a smartphone 100 (refer to FIG. 4) (to be described later). As another example, the communication unit 57 may receive a measurement value of a sensor from a sensor device separate from the electronic timepiece 1. The measurement value received from the sensor device on a real time basis by the communication unit, or the measurement value stored in association with the time in the sensor device is used similarly to the sensor measurement value output by the sensor unit 56 as described above.

The control unit 60 is configured to include a microcontroller including at least a central processing unit (CPU), and controls each unit of the electronic timepiece 1 by executing a program stored in the storage unit 53. For example, the control unit 60 sets an indicating mode of the electronic timepiece 1 in accordance with an operation of a user which is detected by the operation detection unit 55. In accordance with the set indicating mode and the sensor measurement value corresponding to the indicating mode, the control unit 60 controls the drive unit 54 to drive the indicating hand 4. In the embodiment, the control unit 60 functions as an indicating mode setting unit 61, a value setting unit 62, a drive control unit 63, and a communication control unit 64 (to be described below).

For example, the indicating mode setting unit 61 sets the indicating mode of the electronic timepiece 1, based on a detection signal output from the operation detection unit 55 when the A-button 6, the B-button 7, or the C-button 8 is pressed and released by the user. In the embodiment, the indicating mode setting unit 61 can set a time mode, a chronograph mode, an altitude mode, an azimuth mode, a barometric pressure mode, and a pedometer mode in the electronic timepiece 1. Details of each indicating mode will be described later.

The value setting unit 62 sets a value indicated by the electronic timepiece 1. The value setting unit 62 sets the value in accordance with the indicating mode set by the indicating mode setting unit 61. Specifically, the value setting unit 62 sets a time measurement value in the chronograph mode, sets an altitude based on the measurement value of the barometric pressure sensor 563 in the altitude mode, sets an azimuth angle based on the measurement value of the geomagnetic sensor 562 in the azimuth mode, sets barometric pressure based on the measurement value of the barometric pressure sensor 563 in the barometric pressure mode, and sets the number of walking steps counted based on the measurement value of the acceleration sensor 561 in the pedometer mode, as the respective indicating values. The value setting unit 62 may set a common value regardless of the indicating mode. Specifically, as the indicated value, the value setting unit 62 may set the battery remaining capacity based on a signal output from the secondary battery 511 in one or more indicating modes described above.

The drive control unit 63 controls the drive unit 54 to drive the indicating element of the electronic timepiece 1, specifically, the indicating hand 4, so that the value set by the value setting unit 62 is indicated by the indicating hand 4. The drive control unit 63 controls the drive unit 54 to drive the indicating hand 4 so that the indicating mode set by the indicating mode setting unit 61 is indicated. For example, the drive control unit 63 outputs the drive pulse to the drive unit 54 so that the indicating hand 4 (the chronograph secondhand 403 of the center hand 40, the first sub indicating hand 41, and the second sub indicating hand 42) indicates the value or the indicating mode by using the position relationship with the dial 3 (the main dial 30, the first sub dial 31, and the second sub dial 32).

The communication control unit 64 transmits data relating to the value set by the value setting unit 62 to the smartphone 100 (refer to FIG. 4) via the communication unit 57. At this time, for example, the communication control unit 64 transmits the data indicating the indicating mode set by the indicating mode setting unit 61 and the value set by the value setting unit 62, to the smartphone 100. The communication control unit 64 receives a data request from the smartphone 100 via the communication unit 57.

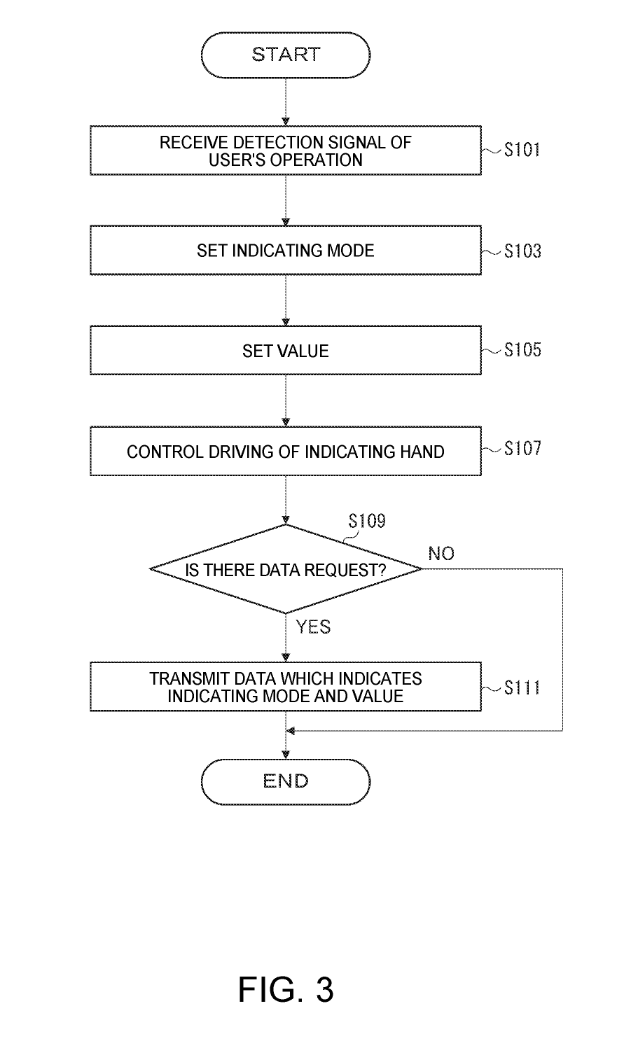

FIG. 3 is a flowchart illustrating a process example in the electronic timepiece according to the embodiment of the invention. The illustrated process is performed by the control unit 60 (the indicating mode setting unit 61, the value setting unit 62, the drive control unit 63, and the communication control unit 64) of the electronic timepiece 1.

First, the indicating mode setting unit 61 receives detection signals of a user's operation from the operation detection unit 55 (Step S101). Here, the received detection signals are respectively output when any one of the A-button 6, the B-button 7, and the C-button 8 is pressed and released.

Next, the indicating mode setting unit 61 sets the indicating mode of the electronic timepiece 1 in accordance with the received detection signal (Step S103). Here, the indicating mode to be set is selected from the settable indicating modes in accordance with the detection signal received in Step S101 and the indicating mode previously set at the time of Step S101. In the embodiment, the user can sequentially switch the time mode, the altitude mode, the azimuth mode, the barometric pressure mode, and the pedometer mode by repeatedly pressing and releasing the A-button 6. The user presses the C-button 8, thereby setting the chronograph mode.

Next, in accordance with the indicating mode set in Step S103, the value setting unit 62 sets the value indicated by the electronic timepiece 1 (Step S105). As described above, for example, the setting value is set, based on the measurement value of the sensor included in the sensor unit 56. The value setting unit 62 may set the value such as the battery remaining capacity, regardless of the indicating mode.

Next, the drive control unit 63 outputs a control pulse to the drive unit 54 so as to indicate the value set in Step S105, thereby controlling the driving of the indicating hand 4 (Step S107). At this time, the drive control unit 63 outputs the control pulse to the drive unit 54 so as to indicate the indicating mode set in Step S103, when indicating the value or before indicating the value, thereby controlling the driving of the indicating hand 4.

Here, in a case where the communication control unit 64 receives the data request from the smartphone 100 (refer to FIG. 4) (YES in Step S109), the communication control unit 64 transmits the data indicating the indicating mode set in Step S103 and the value set in Step S105 to the smartphone 100 via the communication unit 57 (Step S111). On the other hand, in a case where the data request is not received (NO in Step S109), the communication control unit 64 does not transmit the information, and completes the process.

Through the above-described processes, in the electronic timepiece 1, the driving of the indicating hand 4 is controlled so as to indicate the value such as the sensor measurement value or the indicating mode. In a case where the data relating to the value or the indicating mode indicated by the indicating hand 4 is requested, the data is transmitted from the electronic timepiece 1 to the smartphone 100.

### Configuration of System Including Electronic Timepiece

FIG. 4 illustrates a configuration of a system including the electronic timepiece according to the embodiment of the invention. A system 10 includes the electronic timepiece 1 and a smartphone 100. In the illustrated state, a camera 110 of the smartphone 100 is activated, and the camera 110 acquires an image in which the electronic timepiece 1 is included as an imaged subject. At this time, a display 120 serving as a display unit displays an annotation image 122 along with an image 121 including the electronic timepiece 1, which is a so-called live view image.

In the embodiment, the annotation image 122 is generated, based on the data transmitted from the communication unit 57 of the electronic timepiece 1 to the communication unit 150 of the smartphone 100. Specifically, for example, the annotation image indicating the value indicated in the electronic timepiece 1 is displayed. The annotation image indicating the indicating mode set in the electronic timepiece 1 may be displayed. Here, in the embodiment, the annotation image 122 is displayed in association with the indicating element of the electronic timepiece 1 which indicates the value or the indicating mode, specifically, the dial 3, the indicating hand 4, or the date display unit 44.

Since the annotation image 122 is displayed, the user can accurately and easily recognize the information indicated in the electronic timepiece 1. In addition, since the annotation image 122 is associated with the indicating element of the electronic timepiece 1, it is possible to prompt the user to correctly read the information indicated in the electronic timepiece 1.

In the respective drawings subsequent to FIG. 4, the characters marked on the dial 3 of the electronic timepiece 1 are omitted in the illustration, since the characters are too small. References to the characters in the following description are understood with reference to FIG. 1 which illustrates the characters marked on the dial 3 and the respective drawings.

### Configuration of Smartphone

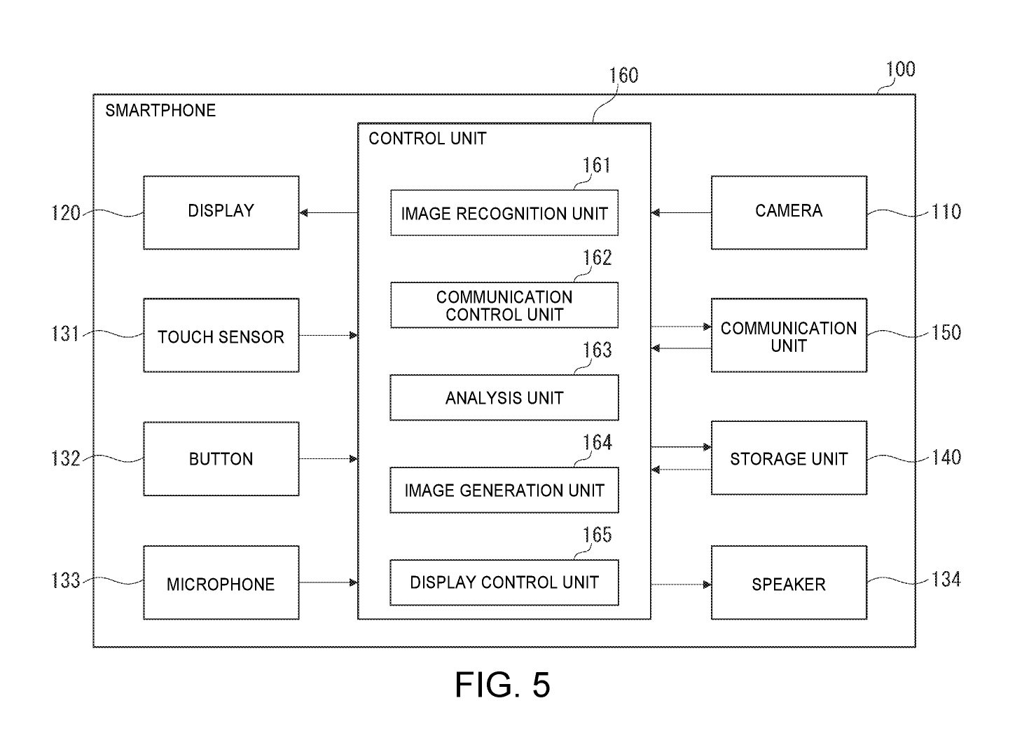

FIG. 5 is a schematic block diagram illustrating a configuration of the smartphone according to the embodiment of the invention. Referring to FIG. 5, the smartphone 100 includes the camera 110, a display 120, a touch sensor 131, a button 132, a microphone 133, a speaker 134, a storage unit 140, a communication unit 150, and a control unit 160.

The camera 110 includes a lens, an image sensor, and an image processing circuit, and converts an optical image incident on the lens into digital image data, thereby outputting the digital image data. The camera 110 continuously outputs the image data at a predetermined frame rate when activated. The image data output in this way is continuously displayed on the display 120, thereby providing a so-called live view image. In the embodiment, the camera 110 serves as an imaging unit that acquires the image in which the electronic timepiece 1 is included as the imaged subject.

For example, the display 120 is a liquid crystal display (LCD) or an organic electro luminescence (EL) display, and displays various information items as the image in accordance with the image data input from the control unit 160. The touch sensor 131 is disposed on the display 120, and a touch screen is configured to include the display 120 and the touch sensor 131. In the embodiment, the display 120 serves as a display unit that displays the annotation image 122 along with the live view image in which the electronic timepiece 1 is included as the imaged subject, which is acquired by the camera 110.

The touch sensor 131 and the button 132 generate an operation signal in accordance with an operation of the user. The generated operation signal is input to the control unit 160. Instead of or in addition to the operation signal, a voice signal generated by the microphone 133 may be input to the control unit 160 as information indicating the operation input of the user. The speaker 134 outputs various information items as a voice in accordance with the voice signal output from the control unit 160.

The storage unit 140 is configured to include the RAM and the ROM. The storage unit 140 stores a program executed by the control unit 160 and data used for executing the program. In the embodiment, the storage unit 140 stores an image dictionary for recognizing the electronic timepiece 1, and the dial 3 and the indicating hand 4 of the electronic timepiece 1. The storage unit 140 stores specification information of the electronic timepiece 1 which is used for associating the value indicated in the electronic timepiece 1 with the indicating element (the dial 3 and the indicating hand 4 or the date display unit 44) of the electronic timepiece 1.

The communication unit 150 includes a device such as a communication circuit and an antenna for performing communication between the smartphone 100 and an external device. For example, the communication unit 150 performs inter-device communication with the external device in accordance with a communication procedure such as the Bluetooth (registered trademark). More specifically, for example, the communication unit 150 performs inter-device communication with the electronic timepiece 1. Furthermore, the communication unit 150 performs the communication using a network such as a mobile communication network or a wireless local area network (LAN), and connects the smartphone 100 to a network such as the Internet.

The control unit 160 is configured to include a processor such as a central processing unit (CPU). The control unit 160 controls each unit of the smartphone 100 by executing the program stored in the storage unit 140. In a case where the program according to the embodiment is executed, the control unit 160 functions as an image recognition unit 161, a communication control unit 162, an analysis unit 163, an image generation unit 164, and a display control unit 165 (to be described below).

The image recognition unit 161 performs an image recognition process for the image 121 acquired by the camera 110. The image recognition unit 161 recognizes the electronic timepiece 1 included as the imaged subject in the image 121. Furthermore, the image recognition unit 161 may recognize the indicating element of the electronic timepiece 1, specifically, the dial 3 and the indicating hand 4 or the date display unit 44. At this time, the image recognition unit 161 recognizes the indicating element by using the image dictionary of the electronic timepiece 1, which is stored in the storage unit 140. For example, the image dictionary may include a first image dictionary including the image of the electronic timepiece 1 of various models and a second image dictionary prepared for each model of the electronic timepiece 1. In this case, the image recognition unit 161 recognizes the model of the electronic timepiece 1 from the image by using the first image dictionary, and recognizes the indicating element of the electronic timepiece 1 from the image by using the second image dictionary corresponding to the recognized model. In another example, the second image dictionary corresponding to the model of the electronic timepiece 1 which is selected in advance by the user may be used. In this case, the first image dictionary is used in determining whether or not the electronic timepiece 1 is included as the imaged subject in the image 121.

The communication control unit 162 exchanges information with the electronic timepiece 1 via the communication unit 150. Specifically, the communication control unit 162 transmits a data request to the electronic timepiece 1 in a case where the electronic timepiece 1 is recognized by the image recognition unit 161. The communication control unit 162 receives the data transmitted by the electronic timepiece 1 in response to the data request. The received data is data relating to the information indicated by the electronic timepiece 1. Specifically, the received data includes data indicating the indicating mode set in the electronic timepiece 1 and the value indicated in accordance with the set indicating mode. In the embodiment, the indicating mode settable in the electronic timepiece 1 includes the time mode, the chronograph mode, the altitude mode, the azimuth mode, the barometric pressure mode, and the pedometer mode. The value indicated in the above-described indicating modes includes the time, the time measurement value, the altitude, the azimuth angle, the barometric pressure, and the number of walking steps. As another example, when a program starts to be executed according to embodiment as will be described later (for example, when an application is activated in the smartphone 100), the communication control unit 162 may transmit the data request to the electronic timepiece 1 regardless of whether or not the electronic timepiece 1 is recognized by the image recognition unit 161.

The analysis unit 163 extracts information from the data received by the communication control unit 162. Based on the specification information of the electronic timepiece stored in the storage unit 140, the analysis unit 163 associates the extracted information with the indicating element of the electronic timepiece 1. The specification information may be stored in the storage unit 140 in the smartphone 100 as described above, or may be transmitted from the electronic timepiece 1 to the smartphone 100 along with data relating to the information indicated by the electronic timepiece 1. A specific example of the specification information will be described later.

The image generation unit 164 generates the annotation image 122 relating to the information extracted from the data received by the communication control unit 162. Specifically, the image generation unit 164 may generate the annotation image 122 relating to the value indicated in the electronic timepiece 1, and may generate the annotation image 122 relating to the indicating mode set in the electronic timepiece 1. The annotation image 122 may directly indicate the value or the indicating mode, and may indicate how the value or the indicating mode is indicated in the electronic timepiece 1 (for example, which indicating element indicates the value or the indicating mode).

The display control unit 165 causes the display 120 to display the annotation image 122 generated by the image generation unit 164 along with the image 121. Specifically, the display control unit 165 displays the annotation image 122 in association with the indicating element of the electronic timepiece 1. For example, the indicating element of the electronic timepiece 1 includes the dial 3 (the main dial 30, the first sub dial 31, or the second sub dial 32), the indicating hand 4 (the chronograph second hand 403 of the center hand 40, the first sub indicating hand 41, or the second sub indicating hand 42), or the date display unit 44. The annotation image 122 may be displayed by being transparently superimposed on the image 121. In a case where the position of the electronic timepiece 1 is changed inside the image 121 due to the movement of the user, the display control unit 165 may use a recognition result of the indicating element of the electronic timepiece 1 which is obtained by the image recognition unit 161 so that the annotation image 122 moves to follow the movement of the electronic timepiece 1 inside the image 121. A specific display example of the annotation image 122 will be described later.

### Example of Process Flow

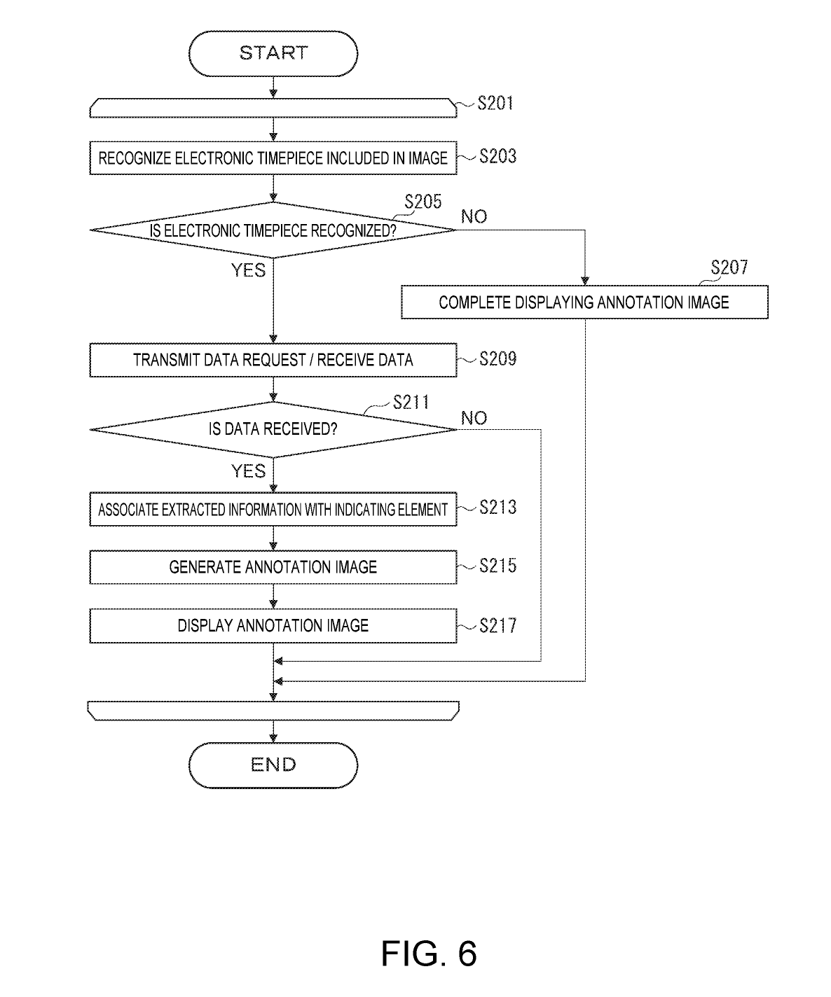

FIG. 6 is a flowchart illustrating an example of an information display method according to the embodiment of the invention. In executing the program according to the embodiment, the illustrated process is repeatedly performed at a predetermined interval by the control unit 160 (the image recognition unit 161, the communication control unit 162, the image generation unit 164, and the display control unit 165) of the smartphone 100 (Step S201).

In each process, first, the image recognition unit 161 recognizes the electronic timepiece 1 included in the image 121 acquired by the camera 110 (Step S203). At this time, the image recognition unit 161 recognizes the electronic timepiece 1 by using the first image dictionary stored in the storage unit 140. The first image dictionary is prepared for a predetermined model of the electronic timepiece 1 which can communicate with the smartphone 100. Therefore, in addition to a case where no timepiece is included in the image 121, the electronic timepiece 1 is not recognized in Step S203 even in a case where the timepiece included in the image 121 is not the predetermined model.

Furthermore, in Step S203, the image recognition unit 161 recognizes the indicating element of the electronic timepiece 1, specifically, the dial 3, the indicating hand 4, or the date display unit 44. At this time, the image recognition unit 161 recognizes the indicating element by using the second image dictionary stored in the storage unit 140. The second image dictionary is prepared for each model of the electronic timepiece 1 where the first image dictionary used in Step S203 is prepared. The second image dictionary and the model of the electronic timepiece 1 are not necessarily prepared one to one, and the second image dictionary common to a plurality of models of the electronic timepiece 1 may be prepared. The process of recognizing the indicating element of the electronic timepiece 1 may be performed until Step S213 (to be described later), and an anterior-posterior relationship between Step S205, and S209 to S211 is optionally determined.

Here, in order to recognize the indicating element of the electronic timepiece 1, the second image dictionary selected by using the recognition result of the model of the electronic timepiece 1 is used. Accordingly, the indicating element of the electronic timepiece 1 can be very accurately recognized. For example, even in a case where a plurality of hands included in the indicating hand 4 overlap each other, it is possible to recognize an individual hand as long as any one of the tip, the middle portion, and the root of each hand appears. In a case where the hand is hidden (for example, in a case where the short hand 411 or the long hand 412 on the first sub dial 31 is hidden behind the hour hand 401 or the minute hand 402 on the main dial 30), it is possible to specify that the hand is located in a hidden region.

As another example, the image recognition unit 161 may specify a position of the indicating element of the electronic timepiece 1 inside the image 121, based on the data (indicating the indicating mode and the value) received from the electronic timepiece 1 in Step S209 (to be described later) and a position and a posture of the electronic timepiece 1 recognized in the image 121. Specifically, for example, the image recognition unit 161 may specify the position on the first scale 301 indicated by the chronograph second hand 403 inside the image 121, based on the value indicated by the chronograph second hand 403, a plane center of the main dial 30 specified based on the position and the posture of the electronic timepiece 1, and a position of “0” (direction of 12 o'clock) of the first scale 301.

Here, in a case where the electronic timepiece 1 is not recognized in Step S203 (NO in Step S205), the display control unit 165 causes the display 120 to terminate the display of the annotation image 122 (in a case where there is a display) (Step S207), and the process at this time is completed. On the other hand, in a case where the electronic timepiece 1 is recognized in Step S203 (YES in Step S205), the process proceeds to Step S209.

Next, the communication control unit 162 transmits the data request to the electronic timepiece 1 and receives the data from the electronic timepiece 1 via the communication unit 150 (Step S209). Here, for example, in a case where there is no pairing with the electronic timepiece 1 required in the communication procedure such as the Bluetooth (registered trademark) which is performed by the communication unit 150, the display control unit 165 may cause the display 120 to display a message prompting pairing with the electronic timepiece 1. In this case, after pairing with the electronic timepiece 1 is performed by the user, the process in Step S209 starts again.

Here, in a case where in Step S209, the data request is not transmitted to the electronic timepiece 1 since the pairing with the electronic timepiece 1 is not performed, and in a case where the data request is transmitted but the data is not received from the electronic timepiece 1 (NO in Step S211), the process at this time is completed. On the other hand, in a case where the data is received from the electronic timepiece 1 in response to the data request transmitted in Step S209 (YES in Step S211), the process proceeds to Step S213.

Next, the analysis unit 163 associates the information extracted from the data received in Step S209 with the indicating element of the electronic timepiece 1, based on the specification information of the electronic timepiece 1 (Step S213). Specifically, the analysis unit 163 associates the information indicating the indicating mode set in the electronic timepiece 1 with the indicating element such as the indicating hand 4 indicating the indicating mode. The analysis unit 163 associates the information indicating the value indicated in the electronic timepiece 1 with the indicating element such as the indicating hand 4 indicating the value.

Next, the image generation unit 164 generates the annotation image 122 relating to the information extracted from the data received in Step S209 (Step S215). For example, in a case where the electronic timepiece 1 is newly recognized in Step S203, the image generation unit 164 newly generates the annotation image 122, based on the data received in Step S209. In a case where the electronic timepiece 1 already recognized in the previous process is still recognized in Step S203, the image generation unit 164 updates the annotation image 122 in a case where the indicating mode and the value indicated by the data received in Step S209 are different from those of the previous process.

Next, the display control unit 165 causes the display 120 to display the annotation image 122 generated by the image generation unit 164 along with the image 121 where the electronic timepiece 1 is included as the imaged subject (Step S217). Specifically, the display control unit 165 outputs the image data in which the annotation image 122 is transparently superimposed on the image 121 (may be an image having a frame different from that of the image 121 used in the image recognition process in Step S203) acquired by the camera 110, to the display 120. At this time, the display control unit 165 displays the annotation image 122 in association with the indicating element such as the indicating hand 4 of the electronic timepiece 1, based on an association result obtained by the analysis unit 163.

While the program according to the embodiment is executed, the above-described processes are repeatedly performed at a predetermined interval by the control unit 160. Therefore, the annotation image 122 newly displayed in Step S217 above is updated in Step S217 performed next time or continuously displayed. Alternatively, in a case where the electronic timepiece 1 is not recognized in Step S203, Step S207 is performed, and the display of the annotation image 122 is completed.

### Display Example

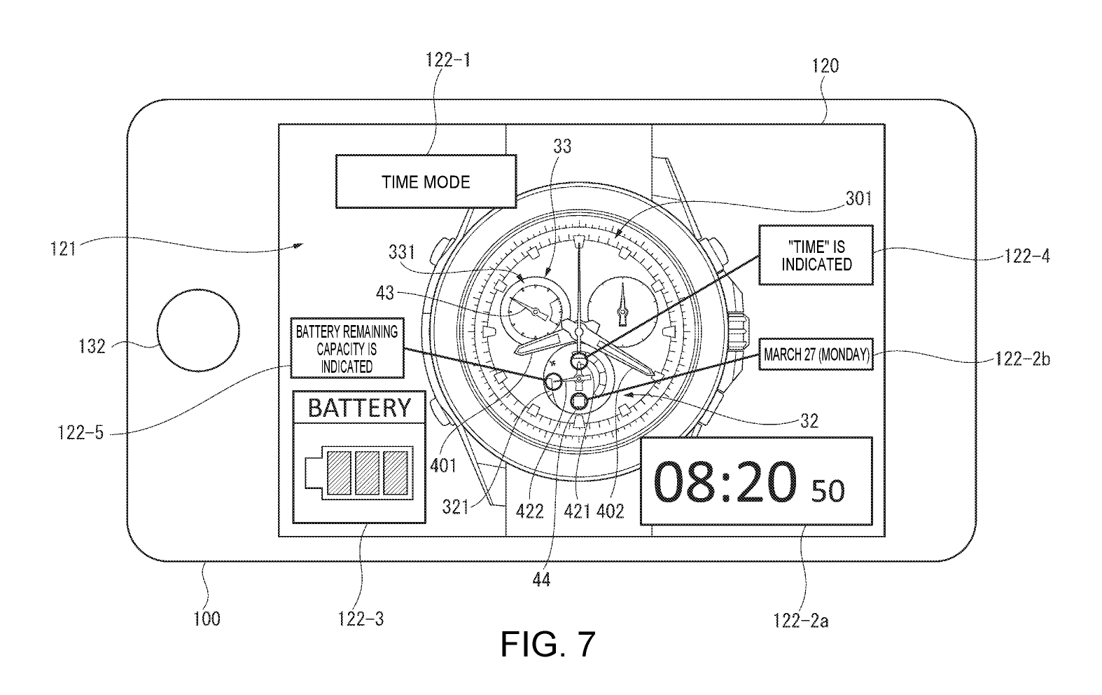

FIG. 7 illustrates a first screen display example according to the embodiment of the invention. In the illustrated example, the time mode is set in the electronic timepiece 1. In the electronic timepiece 1, while the time mode is set, the short hand 421 on the second sub dial 32 indicates a portion having the character of “TIME” marked thereon, and the long hand 422 indicates a portion having the scale 321 marked thereon for indicating the battery remaining capacity. In accordance with the data request, the electronic timepiece 1 transmits the data indicating the set indicating mode (time mode), and the data indicating the time indicated in the time mode and the value of the battery remaining capacity, to the smartphone 100.

In the illustrated example, based on the data received by the communication control unit 162, the image generation unit 164 generates an annotation image 122-1 indicating the indicating mode (time mode) set in the electronic timepiece 1, and the display control unit 165 causes the display 120 to display the annotation image 122-1 along with the image 121. Here, regardless of the indicating hand 4 (the short hand 421 and the long hand 422 on the second sub dial 32) indicating the time mode, the annotation image 122-1 is disposed in an upper left region of the display 120.

In the illustrated example, based on the data received by the communication control unit 162, the image generation unit 164 generates an annotation image 122-2a indicating the time indicated in the electronic timepiece 1, and the display control unit 165 causes the display 120 to display the annotation image 122-2a along with the image 121. Regardless of the indicating hand 4 (the hour hand 401, the minute hand 402, and the small second hand 43) indicating the time, similarly to the annotation image 122-1, the annotation image 122-2a is disposed in a lower right region of the display 120.

On the other hand, in the illustrated example, based on the data received by the communication control unit 162, the image generation unit 164 generates an annotation image 122-2b indicating the date indicated in the electronic timepiece 1. The display control unit 165 displays the annotation image 122-2b in association with the date display unit 44 included as the imaged subject in the image 121.

Furthermore, in the illustrated example, based on the data received by the communication control unit 162, the image generation unit 164 generates an annotation image 122-3 indicating the battery remaining capacity indicated in the electronic timepiece 1, and the display control unit 165 causes the display 120 to display the annotation image 122-3 along with the image 121. Regardless of the indicating hand 4 (the longhand 422 on the second sub dial 32) indicating the battery remaining capacity, similarly to the annotation images 122-1 and 122-2a, the annotation image 122-3 is disposed in the lower left region of the display 120.

In the illustrated example, based on the data received by the communication control unit 162, the image generation unit 164 generates other annotation images 122-4 and 122-5 relating to the indicating mode (time mode) set in the electronic timepiece 1. The annotation image 122-4 indicates that the short hand 421 on the second sub dial 32 indicates a portion having the character of “TIME” marked thereon in the time mode, and is displayed in association with the short hand 421 included as the imaged subject in the image 121. The annotation image 122-5 indicates that the long hand 422 on the second sub dial 32 indicates a portion having a scale 321 marked thereon for indicating the battery remaining capacity in the time mode, and is displayed in association with the long hand 422 included as the imaged subject in the image 121.

In order to generate annotation images 122-2b, 122-4, and 122-5 described above, the analysis unit 163 associates the information extracted from the data received by the communication control unit 162 with the indicating element of the electronic timepiece 1, based on specification information of the electronic timepiece 1. In the above-described example, the analysis unit 163 associates the time mode with the short hand 421 and the long hand 422 on the second sub dial 32, and associates the date with the date display unit 44.

In the first screen display example as described above, the annotation images 122-4 and 122-5 are displayed in association with the indicating element (the short hand 421 and the long hand 422 on the second sub dial 32) indicating the time mode in the electronic timepiece 1. In this manner, for example, even in a case where the user directly views the electronic timepiece 1 without using the smartphone 100, the user can easily recognize that the time mode is set. In the above-described example, the annotation image 122-2b is displayed in association with the indicating element (the date display unit 44) which displays the date in the electronic timepiece 1. In this manner, for example, even in a case where the user directly views the electronic timepiece 1 without using the smartphone 100, the user can easily recognize that the date is displayed by the date display unit 44.

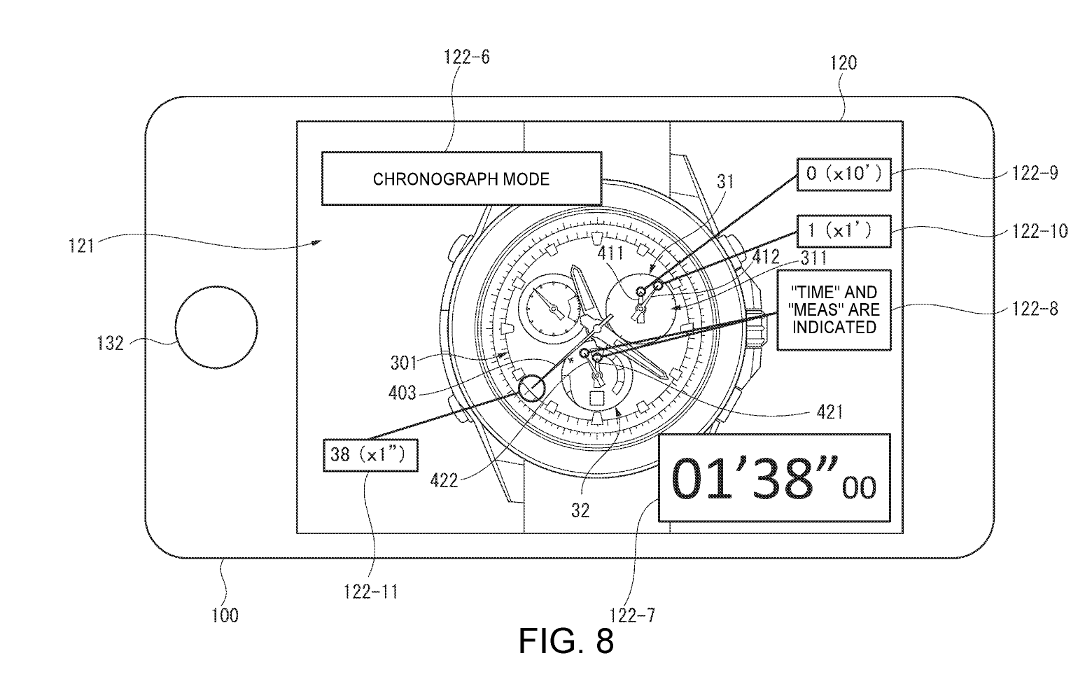

FIG. 8 illustrates a second screen display example according to the embodiment of the invention. In the illustrated example, the chronograph mode is set in the electronic timepiece 1. In the electronic timepiece 1, the chronograph mode is set, for example, in a case where the C-button 8 is pressed while the time mode is set. In the electronic timepiece 1, while the chronograph mode is set, the short hand 421 on the second sub dial 32 indicates a portion having the character of “TIME” marked thereon, and the long hand 422 indicates a portion having the character of “MEAS” marked thereon. In accordance with the data request, the electronic timepiece 1 transmits the data indicating the set indicating mode (chronograph mode) and the data indicating the time measurement value indicated in the chronograph mode, to the smartphone 100.

In the illustrated example, based on the data received by the communication control unit 162, the image generation unit 164 generates an annotation image 122-6 indicating the indicating mode (chronograph mode) set in the electronic timepiece 1, and the display control unit 165 causes the display 120 to display the annotation image 122-6 along with the image 121. The annotation image 122-6 is disposed in the upper left region of the display 120, similarly to the annotation image 122-1 in the example illustrated in FIG. 7.

In the illustrated example, based on the data received by the communication control unit 162, the image generation unit 164 generates an annotation image 122-7 indicating the time measurement value (1 minute 38 seconds) indicated in the electronic timepiece 1, and the display control unit 165 causes the display 120 to display the annotation image 122-7 along with the image 121. The annotation image 122-7 is disposed in the lower right region of the display 120, similarly to the annotation image 122-2a in the example illustrated in FIG. 7.

In the illustrated example, based on the data received by the communication control unit 162, the image generation unit 164 generates another annotation image 122-8 relating to the indicating mode (chronograph mode) set in the electronic timepiece 1. The annotation image 122-8 indicates that the short hand 421 on the second sub dial 32 indicates a portion having the character of “TIME” marked thereon in the chronograph mode, the long hand 422 indicates a portion having the character of “MEAS” marked thereon, and is displayed in association with each of the short hand 421 and the long hand 422 which are included as the imaged subject in the image 121.

Furthermore, in the illustrated example, based on the data received by the communication control unit 162, the image generation unit 164 generates other annotation images 122-9 to 122-11 relating to the time measurement value indicated in the electronic timepiece 1. The annotation image 122-9 indicates that the value (0 at this time point) of the scale 311 indicated by the short hand 411 on the first sub dial 31 is the time measurement value in units of 10 minutes, and is displayed in association with the short hand 411 included as the imaged subject in the image 121. Similarly, the annotation image 122-10 indicates that the value (1 at this time point) of the scale 311 indicated by the long hand 412 on the first sub dial 31 is the time measurement value in units of 1 minute, and is displayed in association with the longhand 412 included as the imaged subject in the image 121. The annotation image 122-11 indicates that the value (38 at this time point) of the first scale 301 indicated by the chronograph second hand 403 on the main dial 30 is the time measurement value in units of 1 second, and is displayed in association with the chronograph second hand 403 included as the imaged subject in the image 121.

In order to display the annotation images 122-8 to 122-11 described above, the analysis unit 163 refers to the specification information of the electronic timepiece 1 similarly to the example illustrated in FIG. 7. In the above-described example, the analysis unit 163 associates the chronograph mode with the short hand 421 and the long hand 422 on the second sub dial 32, and associates a plurality of elements of the time measurement values (measurement values in units of 10 minutes, 1 minute, and 1 second) with the short hand 411 and the long hand 412 on the first sub dial 31 and the chronograph second hand 403 on the main dial 30, respectively.

In the above-described example, the indicating element of the electronic timepiece 1 includes a first indicating element (the short hand 411 and the long hand 412 on the first sub dial 31) and a second indicating element (the chronograph second hand 403 on the main dial 30). The electronic timepiece 1 indicates a first value (time measurement value in units of 10 minutes and 1 minute) by using the first indicating element and a second value (time measurement value in units of 1 second) different from the first value by using the second indicating element. In the smartphone 100, the display control unit 165 causes the display 120 to display the first annotation images 122-9 and 122-10 relating to the first value in association with the first indicating element (the short hand 411 and the long hand 412), and causes the display 120 to display the second annotation image 122-11 relating to the second value in association with the second indicating element (the chronograph secondhand 403). Here, the time measurement value indicated in the electronic timepiece 1 is a third value in which the first value (measurement value in units of 10 minutes and 1 minute) and the second value (measurement value in units of 1 second) are integrated with each other, and the display control unit 165 causes the display 120 to display a third annotation image 122-7 relating to the third value.

In the second screen display example as described above, the annotation image 122-8 is displayed in association with the indicating hand (the short hand 421 and the long hand 422 on the second sub dial 32) indicating the chronograph mode in the electronic timepiece 1. Accordingly, the user easily recognizes that the indicating hands indicate the chronograph mode. In the above-described example, the annotation images 122-9 to 122-11 are displayed in association with each of the indicating hands (the short hand 411 and the long hand 412 on the first sub dial 31, and the chronograph second hand 403) in which the time measurement value is decomposed into a plurality of elements for display in the electronic timepiece 1. Accordingly, the user easily recognizes which element of the time measurement value is indicated by the indicating hands. In this manner, for example, even in a case where the user directly views the electronic timepiece 1 without using the smartphone 100, the user can easily recognize that the chronograph mode is set, and the time measurement value indicated in the chronograph mode.

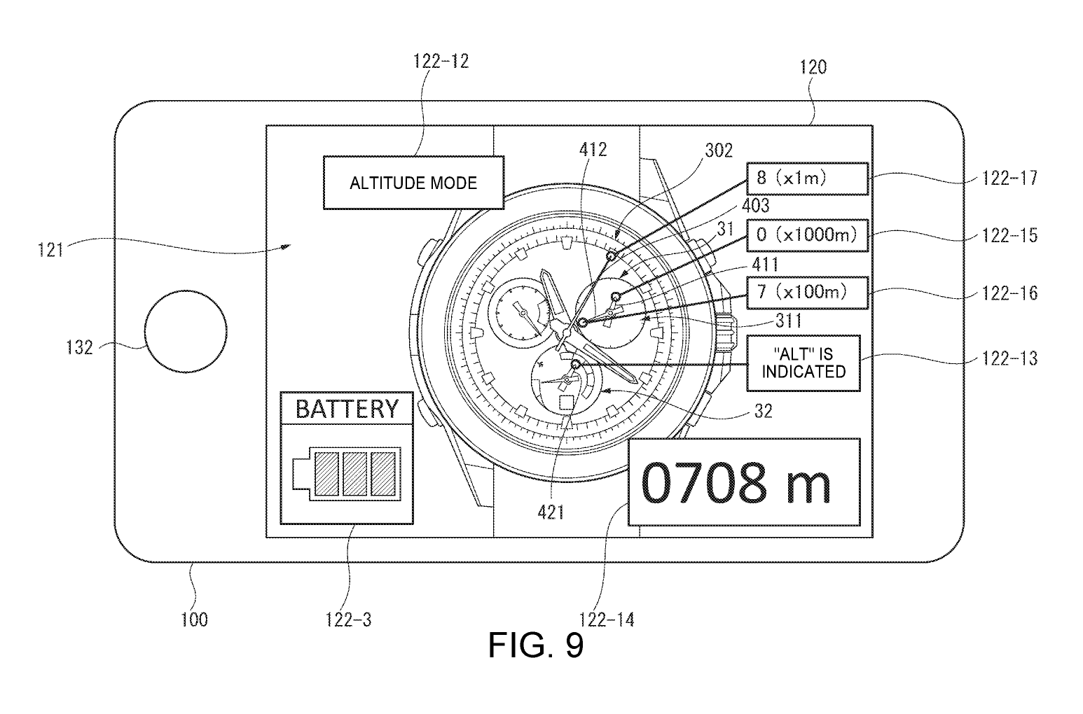

FIG. 9 illustrates a third screen display example according to the embodiment of the invention. In the illustrated example, the altitude mode is set in the electronic timepiece 1. In the electronic timepiece 1, the altitude mode is set, for example, in a case where the A-button 6 is pressed and released while the time mode is set. In the electronic timepiece 1, while the altitude mode is set, the short hand 421 on the second sub dial 32 indicates a portion having the character of “ALT” marked thereon. In accordance with the data request, the electronic timepiece 1 transmits the data indicating the set indicating mode (altitude mode) and the data indicating the altitude measurement value indicated in the altitude mode, to the smartphone 100.

In the illustrated example, based on the data received by the communication control unit 162, the image generation unit 164 generates an annotation image 122-12 indicating the indicating mode (altitude mode) set in the electronic timepiece 1, and the display control unit 165 causes the display 120 to display the annotation image 122-12 along with the image 121. The annotation image 122-12 is disposed in the upper left region of the display 120, similarly to the annotation image 122-1 in the example illustrated in FIG. 7.

In the illustrated example, based on the data received by the communication control unit 162, the image generation unit 164 generates another annotation image 122-13 relating to the indicating mode (altitude mode) set in the electronic timepiece 1. The annotation image 122-13 indicates that the short hand 421 on the second sub dial 32 indicates a portion having the character of “ALT” marked thereon in the altitude mode, and is displayed in association with the short hand 421 included as the imaged subject in the image 121.

On the other hand, in the illustrated example, based on the data received by the communication control unit 162, the image generation unit 164 generates an annotation image 122-14 indicating the altitude measurement value (708 m in the illustrated example) indicated in the electronic timepiece 1, and the display control unit 165 causes the display 120 to display the annotation image 122-14 along with the image 121. The annotation image 122-14 is disposed in the lower right region of the display 120, similarly to the annotation image 122-2a in the example illustrated in FIG. 7.

Furthermore, based on the data received by the communication control unit 162, the image generation unit 164 generates other annotation images 122-15 to 122-17 relating to the altitude measurement value indicated in the electronic timepiece 1. The annotation image 122-15 indicates that the value (at this time point, smaller than 1, that is, 0) of the scale 311 indicated by the short hand 411 on the first sub dial 31 is the altitude measurement value in units of 1000 m. The display control unit 165 displays the annotation image 122-15 in association with the short hand 411 included as the imaged subject in the image 121. Similarly, the annotation image 122-16 indicates that the value (7 at this time point) of the scale 311 indicated by the long hand 412 on the first sub dial 31 is the altitude measurement value in units of 100 m, and is displayed in association with the long hand 412 included as the imaged subject in the image 121. The annotation image 122-17 indicates that the value (8 at this time point) of the second scale 302 indicated by the chronograph second hand 403 on the main dial 30 is the altitude measurement value in units of 1 m, and is displayed in association with the chronograph second hand 403 included as the imaged subject in the image 121.

In order to display the annotation images 122-13, and 122-15 to 122-17 described above, the analysis unit 163 refers to the specification information of the electronic timepiece 1, similarly to the example illustrated in FIG. 7. In the above-described example, the analysis unit 163 associates the altitude mode with the short hand 421 on the second sub dial 32, and associates a plurality of elements (measurement values in units of 1,000 m, 100 m, and 1 m) of the altitude measurement values with the short hand 411 and the long hand 412 on the first sub dial 31 and the chronograph second hand 403 on the main dial 30, respectively.

In the illustrated example, similarly to the example illustrated in FIG. 7, the annotation image 122-3 indicating the battery remaining capacity is displayed. In the embodiment, the annotation image 122-3 is displayed in a case where the other annotation image 122 is not displayed in the lower left region of the display 120 regardless of the indicating mode set in the electronic timepiece 1 (the annotation image 122-3 illustrated in the following example will not be particularly described).

In the third screen display example as described above, similarly to the second screen display example, the annotation image 122-13 is displayed in association with the indicating hand (the short hand 421 on the second sub dial 32) indicating the altitude mode in the electronic timepiece 1. Accordingly, the user easily recognizes that the indicating hand indicates the altitude mode. In the above-described example, similarly to the second screen display example, the annotation images 122-15 to 122-17 are displayed in association with each of the indicating hands (the short hand 411 and the long hand 412 on the first sub dial 31, and the chronograph second hand 403) in which the altitude measurement value is decomposed into a plurality of elements for display in the electronic timepiece 1. Accordingly, the user easily recognizes which element of the altitude measurement value is indicated by the indicating hands. In this manner, for example, even in a case where the user directly views the electronic timepiece 1 without using the smartphone 100, the user can easily recognize that the altitude mode is set, and the altitude measurement value indicated in the altitude mode.

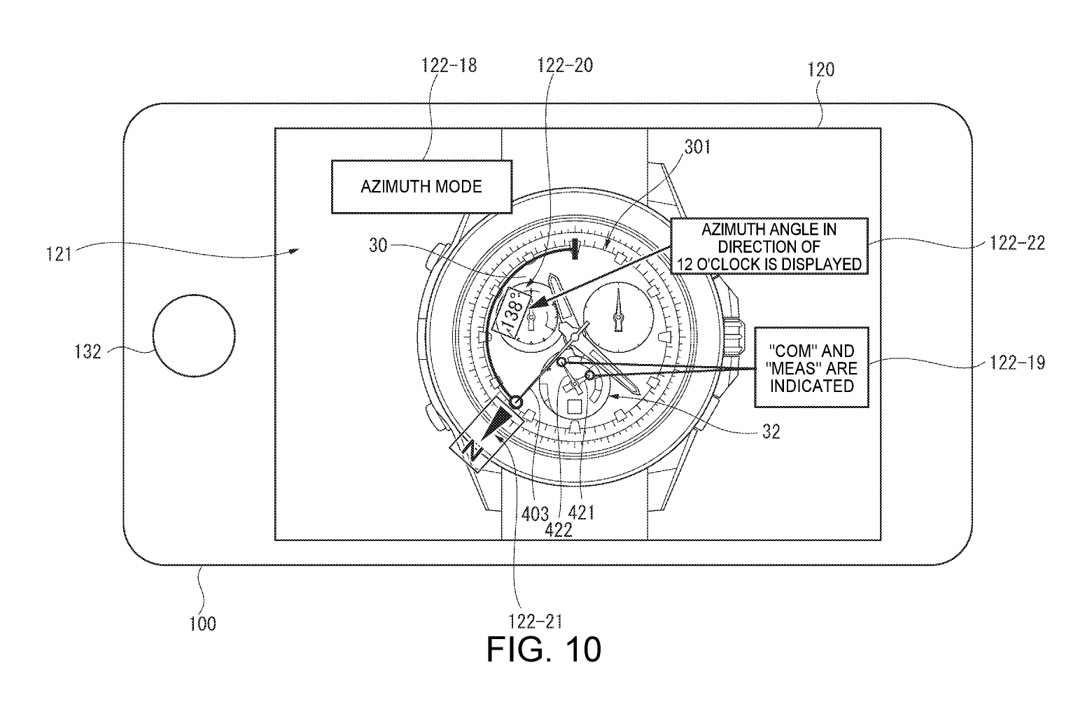

FIG. 10 illustrates a fourth screen display example according to the embodiment of the invention. In the illustrated example, the azimuth mode is set in the electronic timepiece 1. In the electronic timepiece 1, the azimuth mode is set, for example, in a case where the A-button 6 is pressed and released while the altitude mode is set. In the electronic timepiece 1, while the azimuth mode is set, the short hand 421 on the second sub dial 32 indicates a portion having the character of “COM” marked thereon, and the long hand 422 indicates a portion having the character of “MEAS” marked thereon. In accordance with the data request, the electronic timepiece 1 transmits the data indicating the indicating mode (azimuth mode) set and the data indicating the azimuth angle measurement value indicated in the azimuth mode, to the smartphone 100.

In the illustrated example, based on the data received by the communication control unit 162, the image generation unit 164 generates an annotation image 122-18 indicating the indicating mode (azimuth mode) set in the electronic timepiece 1, and the display control unit 165 causes the display 120 to display the annotation image 122-18 along with the image 121. The annotation image 122-18 is disposed in the upper left region of the display 120, similarly to the annotation image 122-1 in the example illustrated in FIG. 7.

In the illustrated example, based on the data received by the communication control unit 162, the image generation unit 164 generates another annotation image 122-19 relating to the indicating mode (azimuth mode) set in the electronic timepiece 1. The annotation image 122-19 indicates that the short hand 421 on the second sub dial 32 indicates a portion having the character of “COM” marked thereon in the azimuth mode and the long hand 422 indicates a portion having the character of “MEAS” marked thereon, and is displayed in association with the short hand 421 and the longhand 422 which are included as the imaged subject in the image 121.

On the other hand, in the illustrated example, the image generation unit 164, based on the data received by the communication control unit 162, the image generation unit 164 generates an annotation image 122-20 indicating the azimuth measurement value (138° in the illustrated example) indicated in the electronic timepiece 1. The annotation image 122-20 includes an arc having an angle corresponding to the azimuth angle measurement value (that is, as large as 138°) and a number indicating the azimuth angle measurement value. The display control unit 165 displays the annotation image 122-20 by superimposing the annotation image 122-20 on a section from a zero position (12 o'clock) of the first scale 301 of the main dial 30 included as the imaged subject in the image 121 up to the tip of the chronograph secondhand 403 along the first scale 301.

In the above-described example, the value setting unit 62 of the electronic timepiece 1 calculates the azimuth angle measurement value, based on a measurement result of the geomagnetic sensor 562 in the electronic timepiece 1. The azimuth angle represents an angle in a direction of 12 o'clock when viewed from the plane center of the main dial 30 in a case where the dial 3 is held in substantially the horizontal direction and the direction toward the north is set to 0°. In the illustrated example, the azimuth angle is 90° if the direction of 12 o'clock is the east, is 180° if the direction of 12 o'clock is the south, and is 270° if the direction of 12 o'clock is the west. One scale of the first scale 301 which divides the outer periphery of the main dial 30 into 60 corresponds to the azimuth angle of 6°.

Furthermore, in the illustrated example, based on the data received by the communication control unit 162, the image generation unit 164 generates other annotation images 122-21 and 122-22 relating to the azimuth angle measurement value indicated in the electronic timepiece 1. The annotation image 122-21 indicates that the direction indicated by the chronograph second hand 403 is the north direction specified based on the azimuth angle measurement value. The display control unit 165 displays the annotation image 122-21 on an extension line of the chronograph secondhand 403. Similarly, the annotation image 122-22 indicates that the azimuth angle indicated by the annotation image 122-20 is the azimuth angle in the direction of 12 o'clock, and is displayed in association with a numerical portion indicating the azimuth angle measurement value of the annotation image 122-20.

In order to display the annotation images 122-19 to 122-21 described above, the analysis unit 163 refers to the specification information of the electronic timepiece 1, similarly to the example illustrated in FIG. 7. In the above-described example, the analysis unit 163 associates the azimuth mode with the short hand 421 and the long hand 422 on the second sub dial 32, and associates the azimuth angle measurement value with the chronograph second hand 403 on the main dial 30.

In the fourth screen display example as above, similarly to the second and third screen display examples, the annotation image 122-19 is displayed in association with the indicating hand (the short hand 421 on the second sub dial 32) indicating the azimuth mode in the electronic timepiece 1. Accordingly, the user easily recognizes that the indicating hand indicates the azimuth mode. In the above-described example, the annotation images 122-20 to 122-22 are displayed in association with the indicating hand (the chronograph second hand 403) indicating the azimuth angle measurement value in the electronic timepiece 1. Accordingly, the user easily recognizes how the indicating hand indicates the azimuth angle measurement value. In this manner, for example, even in a case where the user directly views the electronic timepiece 1 without using the smartphone 100, the user can easily recognize that the azimuth mode is set, and the azimuth angle measurement value indicated in the azimuth mode.

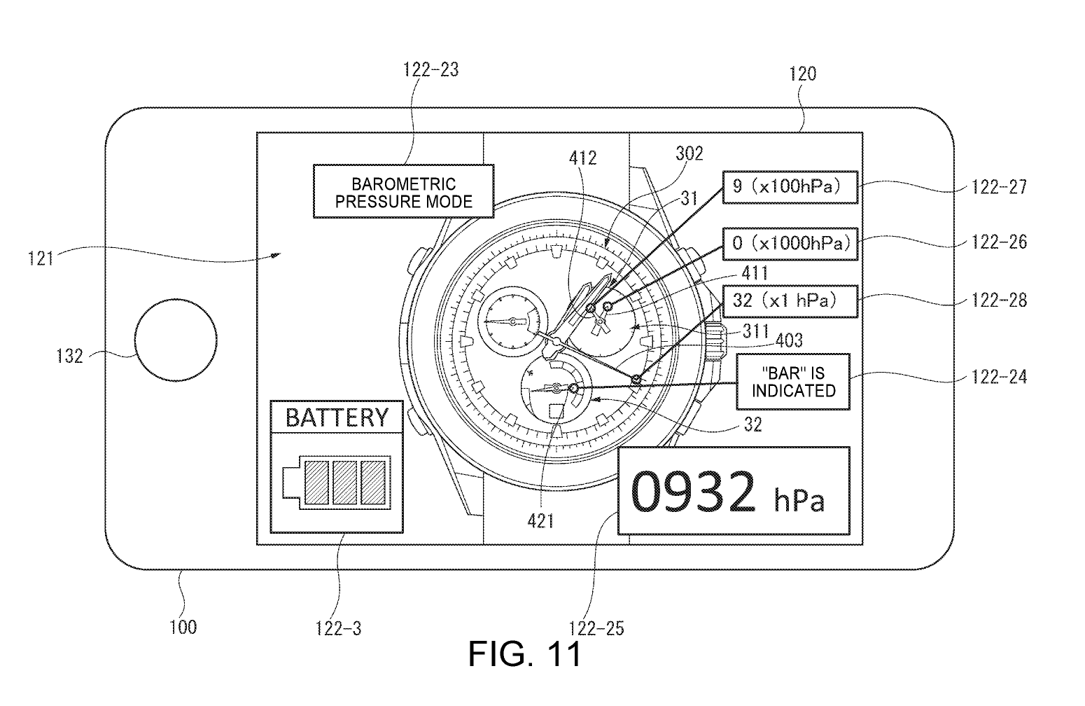

FIG. 11 illustrates a fifth screen display example according to the embodiment of the invention. In the illustrated example, the barometric pressure mode is set in the electronic timepiece 1. In the electronic timepiece 1, the barometric pressure mode is set, for example, in a case where the A-button 6 is pressed and released while the azimuth mode is set. In the electronic timepiece 1, while the barometric pressure mode is set, the short hand 421 on the second sub dial 32 indicates a portion having the character of “BAR” marked thereon. In accordance with the data request, the electronic timepiece 1 transmits the data indicating the set indicating mode (barometric pressure mode) and the data indicating the barometric pressure measurement value in the barometric pressure mode, to the smartphone 100.

In the illustrated example, based on the data received by the communication control unit 162, the image generation unit 164 generates an annotation image 122-23 indicating the indicating mode (barometric pressure mode) set in the electronic timepiece 1, and the display control unit 165 causes the display 120 to display the annotation image 122-23 along with the image 121. The annotation image 122-23 is disposed in the upper left region of the display 120, similarly to the annotation image 122-1 in the example illustrated in FIG. 7.

In the illustrated example, based on the data received by the communication control unit 162, the image generation unit 164 generates another annotation image 122-24 relating to the indicating mode (barometric pressure mode) set in the electronic timepiece 1. The annotation image 122-24 indicates that the short hand 421 on the second sub dial 32 indicates a portion having the character of “BAR” marked thereon in the altitude mode, and is displayed in association with the short hand 421 included as the imaged subject in the image 121.

On the other hand, in the illustrated example, based on the data received by the communication control unit 162, the image generation unit 164 generates an annotation image 122-25 indicating the barometric pressure measurement value (932 hPa in the illustrated example) indicated in the electronic timepiece 1, and the display control unit 165 causes the display 120 to display the annotation image 122-25 along with the image 121. The annotation image 122-25 is disposed in the lower right region of the display 120, similarly to the annotation image 122-2a in the example illustrated in FIG. 7.

Furthermore, in the illustrated example, based on the data received by the communication control unit 162, the image generation unit 164 generates other annotation images 122-26 to 122-28 relating to the barometric pressure measurement value indicated in the electronic timepiece 1. The annotation image 122-26 indicates that the value (at this time point, smaller than 1, that is, 0) of the scale 311 indicated by the short hand 411 on the first sub dial 31 is the barometric pressure measurement value in units of 1,000 hPa. The display control unit 165 displays the annotation image 122-26 in association with the short hand 411 included as the imaged subject in the image 121. Similarly, the annotation image 122-27 indicates that the value (9 at this time point) of the scale 311 indicated by the long hand 412 on the first sub dial 31 is the barometric pressure measurement value in units of 100 hPa, and is displayed in association with the long hand 412 included as the imaged subject in the image 121. The annotation image 122-28 indicates that the value (32 at this time point) of the second scale 302 indicated by the chronograph second hand 403 on the main dial 30 is the barometric pressure measurement value in units of 1 hPa, and is displayed in association with the chronograph second hand 403 included as the imaged subject in the image 121.

In order to display the annotation images 122-24, 122-26 to 122-28 described above, the analysis unit 163 refers to the specification information of the electronic timepiece 1, similarly to the example illustrated in FIG. 7. In the above-described example, the analysis unit 163 associates the barometric pressure mode with the short hand 421 on the second sub dial 32, and associates a plurality of elements (measurement values in units of 1,000 hPa, 100 hPa, and 1 hPa) of the barometric pressure measurement value with the short hand 411 and the long hand 412 on the first sub dial 31, and the chronograph second hand 403 on the main dial 30, respectively.

In the fifth screen display example as described above, similarly to the second to fourth screen display examples, the annotation image 122-24 is displayed in association with the indicating hand (the short hand 421 on the second sub dial 32) indicating the barometric pressure mode in the electronic timepiece 1. Accordingly, the user easily recognizes that the indicating hand indicates the barometric pressure mode. In the above-described example, similarly to the second and third screen display examples, the annotation images 122-26 to 122-28 are displayed in association with each of the indicating hands (the short hand 411 and the long hand 412 on the first sub dial 31, and the chronograph second hand 403) in which the barometric pressure measurement value is decomposed into a plurality of elements for display in the electronic timepiece 1. Accordingly, the user easily recognizes which element of the barometric pressure measurement value is indicated by the indicating hands in the electronic timepiece 1. In this manner, for example, even in a case where the user directly views the electronic timepiece 1 without using the smartphone 100, the user can easily recognize that the barometric pressure mode is set, and the barometric pressure measurement value indicated in the barometric pressure mode.

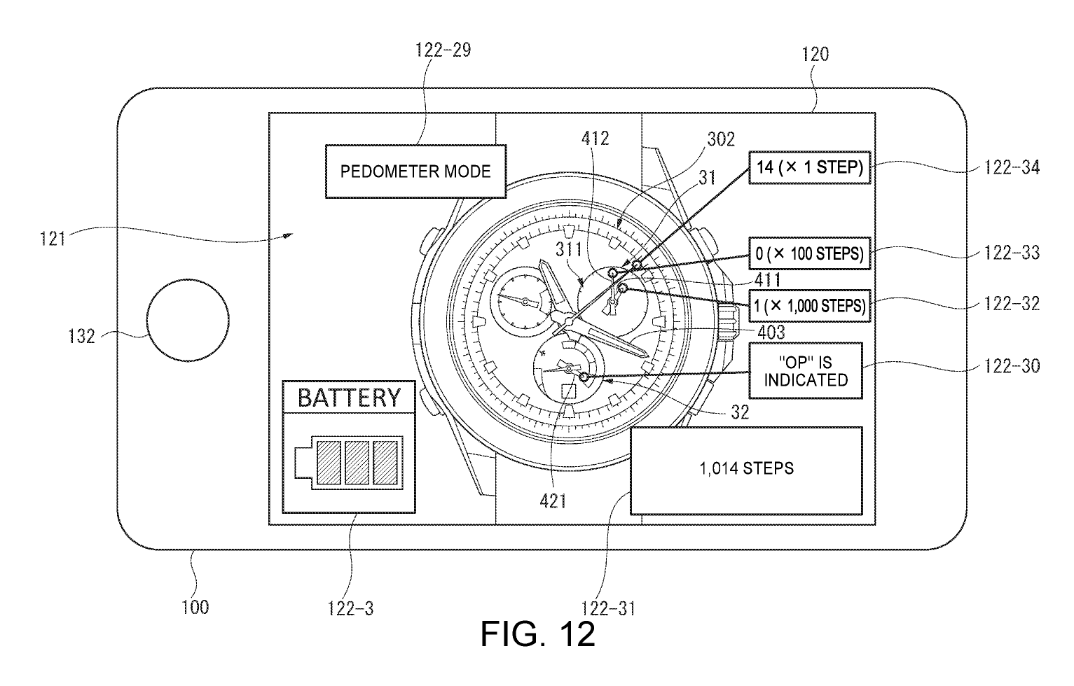

FIG. 12 illustrates a sixth screen display example according to the embodiment of the invention. In the illustrated example, the pedometer mode is set in the electronic timepiece 1. In the electronic timepiece 1, the pedometer mode is set, for example, in a case where the A-button 6 is pressed and released while the barometric pressure mode is set. In the electronic timepiece 1, while the pedometer mode is set, the short hand 421 on the second sub dial 32 indicates a portion having the character of “OP” marked thereon. In accordance with the data request, the electronic timepiece transmits the data indicating the set indicating mode (pedometer mode) and the data indicating the measurement value of the number of walking steps indicated in the pedometer mode, to the smartphone 100.

In the illustrated example, based on the data received by the communication control unit 162, the image generation unit 164 generates an annotation image 122-29 indicating the indicating mode (pedometer mode) set in the electronic timepiece 1, and the display control unit 165 causes the display 120 to display the annotation image 122-29 along with the image 121. The annotation image 122-29 is disposed in the upper left region of the display 120, similarly to the annotation image 122-1 in the example illustrated in FIG. 7.

In the illustrated example, based on the data received by the communication control unit 162, the image generation unit 164 generates another annotation image 122-30 relating to the indicating mode (pedometer mode) set in the electronic timepiece 1. The annotation image 122-30 indicates that the short hand 421 on the second sub dial 32 indicates a portion having the character of “OP” marked thereon in the pedometer mode, and is displayed in association with the short hand 421 included as the imaged subject in the image 121.

On the other hand, in the illustrated example, based on the data received by the communication control unit 162, the image generation unit 164 generates an annotation image 122-31 indicating the measurement value (1,014 steps in the illustrated example) of the number of walking steps indicated in the electronic timepiece 1, and the display control unit 165 causes the display 120 to display the annotation image 122-31 along with the image 121. The annotation image 122-31 is disposed in the lower right region of the display 120, similarly to the annotation image 122-2a in the example illustrated in FIG. 7.

In the pedometer mode as described above, the electronic timepiece 1 may receive the measurement value of a sensor included in an external device (for example, a sensor device separate from the electronic timepiece 1), and may indicate the value based on the received measurement value, as the measurement value of the number of walking steps. Specifically, in the sensor device separate from the electronic timepiece 1, the number of walking steps based on the measurement value of the acceleration sensor may be continuously counted. In the electronic timepiece 1, when the indicating mode setting unit 61 sets the pedometer mode, the communication control unit 64 may receive the measurement value of the number of walking steps from the sensor device.

Furthermore, in the illustrated example, based on the data received by the communication control unit 162, the image generation unit 164 generates other annotation images 122-32 to 122-34 relating to the number of walking steps indicated in the electronic timepiece 1. The annotation image 122-32 indicates that the value (1 at this time point) of the scale 311 indicated by the short hand 411 on the first sub dial 31 is the number of walking steps in units of 1,000. The display control unit 165 displays the annotation image 122-32 in association with the short hand 411 included as the imaged subject in the image 121. Similarly, the annotation image 122-33 indicates that the value (0 at this time point) of the scale 311 indicated by the long hand 412 on the first sub dial 31 is the number of walking steps in units of 100, and is displayed in association with the long hand 412 included as the imaged subject in the image 121. The annotation image 122-34 indicates that the value (14 at this time point) of the second scale 302 indicated by the chronograph second hand 403 on the main dial 30 is the number of walking steps in units of 1, and is displayed in association with the chronograph second hand 403 included as the imaged subject in the image 121.

In order to display the annotation images 122-30, and 122-32 to 122-34 described above, the analysis unit 163 refers to the specification information of the electronic timepiece 1, similarly to the example illustrated in FIG. 7. In the above-described example, the analysis unit 163 associates the pedometer mode with the short hand 421 on the second sub dial 32, and associates a plurality of the elements (the number of walking steps in units of 1,000, 100, and 1) of the measurement value of the number of walking steps with the short hand 411 and the long hand 412 on the first sub dial 31 and the chronograph second hand 403 on the main dial 30, respectively.

In the sixth screen display example as described above, similarly to the second to fifth screen display examples, the annotation image 122-30 is displayed in association with the indicating hand (the short hand 421 on the second sub dial 32) indicating the pedometer mode in the electronic timepiece 1. Accordingly, the user easily recognizes that the indicating hand indicates the pedometer mode. In the above-described example, similarly to the second, third and fifth screen display examples, the annotation images 122-32 to 122-34 are displayed in association with each of the indicating hands (the short hand 411 and the long hand 412 on the first sub dial 31, and the chronograph second hand 403) in which the measurement value of the number of walking steps is decomposed into a plurality of elements for display in the electronic timepiece 1. Accordingly, the user easily recognizes which element of the number of walking steps is indicated by the indicating hands. In this manner, for example, even in a case where the user directly views the electronic timepiece 1 without using the smartphone 100, the user can easily recognize that the pedometer mode is set, and the number of walking steps indicated in the pedometer mode.

Hitherto, the embodiment according to the invention has been described. The embodiment according to the invention is not limited to the above-described examples, and various modified embodiments can be made within the obvious scope to those having ordinary knowledge in the technical field to which the invention belongs. It is understood that the modified embodiments naturally belong to the technical scope of the invention.

For example, in the above-described embodiment, the smartphone 100 has been described as an example of the information display device. However, other devices such as a personal computer, a tablet computer, and a wearable device can be operated as the information display device, similarly to the smartphone 100. In a case where a network server which communicates with a device such as the smartphone 100 including the camera 110 and the display 120 via a network provides at least a partial function of the above-described control unit 160 (the image recognition unit 161, the communication control unit 162, the analysis unit 163, the image generation unit 164, and the display control unit 165), the server functions as the information display device according to the embodiment of the invention.

For example, in the above-described embodiment, an example has been described in which the image dictionary for the image recognition process performed by the image recognition unit 161 of the smartphone 100 is stored in the storage unit 140. However, the image dictionary may be partially or entirely stored in network storage, and the smartphone 100 may download the required image dictionary from the storage by using the communication unit 150, if necessary. Similarly, the specification information of the electronic timepiece 1 which is referred to by the analysis unit 163 may be partially or entirely stored in the network storage, and the smartphone 100 may download the required specification information from the storage, if necessary.

For example, in the above-described embodiment, an example has been described in which the electronic timepiece 1 includes the main dial 30 and the first sub dial 31 to the third sub dial 33 in the dial 3. However, the electronic timepiece 1 may not include the sub dial in the dial 3, or may include two, four or more sub dials in the dial 3. As a method of indicating the value such as the sensor measurement value by using the electronic timepiece 1, various methods can be employed regardless of the examples in the above-described embodiment.

For example, in the above-described embodiment, an example has been described in which the first indicating element (for example, the indicating element is the dial 3, the indicating hand 4, or the date display unit 44) in the electronic timepiece 1 indicates the indicating mode and the second indicating element different from the first indicating element indicates the value. However, in other embodiments, a single indicating element of the electronic timepiece 1 may indicate both the indicating mode and the value. In this case, in the smartphone 100, the display control unit 165 may display both the annotation image 122 on the indicating mode and the annotation image 122 on the value in association with the same indicating element of the electronic timepiece 1.

For example, the embodiment according to the invention may include the information display device, the information display method, the system including the electronic timepiece and the information display device which are described above, the program for providing a function as an information processing device, and a non-transitory tangible medium having the program recorded thereon.

What is claimed is:

1. An information display method comprising:
recognizing an electronic timepiece included as an imaged subject in an image, and an indicating element that indicates information in the electronic timepiece;
receiving data relating to information indicated by the electronic timepiece from the electronic timepiece;
associating information extracted from the data with the indicating element, based on specification information of the electronic timepiece; and
displaying an annotation image relating to the information extracted from the data in association with the indicating element, along with the image.

2. The information display method according to claim 1,
wherein the indicating element includes a dial and an indicating hand that indicates the dial, and
wherein in the displaying the annotation image, the annotation image is displayed in association with the indicating hand.

3. The information display method according to claim 1,
wherein the information indicated by the electronic timepiece includes information based on a measurement value of a sensor included in the electronic timepiece, or information based on a measurement value of a sensor of an external device which is received from the external device.

4. The information display method according to claim 1,
wherein the indicating element includes a first indicating element and a second indicating element,
wherein the information indicated by the electronic timepiece includes a first value indicated by the first indicating element, and a second value indicated by the second indicating element, and
wherein in the displaying the annotation image, a first annotation image relating to the first value is displayed in association with the first indicating element, and a second annotation image relating to the second value is displayed in association with the second indicating element.

5. The information display method according to claim 4,
wherein in the displaying the annotation image, a third annotation image relating to a third value in which the first value and the second value are integrated with each other is displayed along with the first annotation image and the second annotation image.

6. The information display method according to claim 1,
wherein the electronic timepiece indicates the value in accordance with any one of a plurality of settable indicating modes,
wherein the information indicated by the electronic timepiece includes the indicating mode set in the electronic timepiece, and
wherein in the displaying the annotation image, the annotation image relating to the indicating mode is displayed in association with the indicating element that indicates the indicating mode.

7. The information display method according to claim 1, further comprising:
transmitting a data request to the electronic timepiece in a case where the electronic timepiece is recognized in recognizing the electronic timepiece and the indicating element.

8. A system comprising:
an electronic timepiece; and
an information display device,
wherein the electronic timepiece includes an indicating element that indicates information, a drive control unit that controls driving of the indicating element, and an antenna that transmits data relating to the information to the information display device,
wherein the information display device includes a camera that acquires an image, an image recognition unit that recognizes the electronic timepiece and the indicating element which are included as an imaged subject in the image, an antenna that receives the data from the electronic timepiece, an analysis unit that associates information extracted from the data with the indicating element, based on specification information of the electronic timepiece, and a display that displays an annotation image relating to the information extracted from the data in association with the indicating element, along with the image.

9. An information display device comprising:
a camera that acquires an image;
an image recognition unit that recognizes an electronic timepiece included as an imaged subject in the image, and an indicating element which indicates information in the electronic timepiece;
an antenna that receives data relating to information indicated by the electronic timepiece from the electronic timepiece;
an analysis unit that associates information extracted from the data with the indicating element, based on specification information of the electronic timepiece; and
a display that displays an annotation image relating to the information extracted from the data in association with the indicating element, along with the image.
